(19) United States
(12) Patent Application Publication
(10) Pub. No.: US 2005/0250538 A1
(43) Pub. Date: Nov. 10, 2005

(54) Method and system for making card-based payments using mobile devices

(75) Inventors: Ashok Narasimhan, Los Altos Hills, CA (US); Rajesh Reddy, Bangalore (IN); Jyothirmoy Chakravorty, Bangalore (IN); William N. Melton, Vienna, VA (US); Dax Abraham, Bangalore (IN)

Correspondence Address: William L. Botjer, PO Box 478, Center Moriches, NY, 11934, US

(73) Assignee: JULY SYSTEMS, INC., SANTA CLARA, CA (US)

(21) Appl. No.: 10/841,700

(22) Filed: May 7, 2004

(51) Int. Cl. H04M 1/00

(52) U.S. Cl. 455/558; 455/411

(57) ABSTRACT

The present invention provides a system, a method and a computer program product for provisioning Virtual PIN pads on mobile devices, and for enabling customers to make payments using the provisioned Virtual PIN pads for the purchased goods and services. The system comprises a Virtual PIN pad and a transaction backend module. The Virtual PIN pad is a software emulation of a PIN Entry Device (PED) and is provisioned on the mobile device securely with all requisite keys and certificates, while conforming to all security standards of the payment domain. The transaction backend connects the Virtual PIN pad to a payment institution. The customer can make a payment by entering an account identifier card's PIN into the Virtual PIN pad. The Virtual PIN pad encrypts the entered PIN using certified security mechanisms, and transmits it over a secure channel to the payment institution for verification and payment authorization, via the transaction backend. The backend ensures the integrity of transaction in the mobile data environment.

### BACKGROUND

The present invention relates to mobile payments for purchased goods or services. More specifically, the present invention relates to a method and a system for making payments through mobile devices using a virtual Personal Identification Number (PIN) pad integrated with the mobile devices.

Paying for transactions via a credit card or a debit card at point of sales [POS] terminals has gained significant popularity. This is because card transactions benefit both a payer and a payee. A Payer benefits, as this mode of payment is safer than carrying cash and faster than writing a check. Payees prefer payment via card transactions as it offers enhanced security. This is because in this case, money is guaranteed as it is transferred straight from the payer's bank account to the payee's bank account.

Currently, in order to make card-based transactions at a merchant's location, Electronic Fund Transfer Point of Sale [EFTPOS] terminals are required. An account identifier card having a valid PIN, such as a debit card is swiped through the EFTPOS terminal. The payer is then required to enter the corresponding PIN. The entered PIN is sent to a bank for electronic authorization of the card transaction. The PIN is a secret code to identify the cardholder (payer) and verify the account identifier card. The PIN is either selected by the cardholder or assigned by the bank, which issues the account identifier card. For security reasons, the PIN is known only to the cardholder and to the card issuer's computer system.

During a debit transaction, the PIN is entered into a PIN Entry Device (PED) also known as a PIN pad attached to the EFTPOS. The PIN pad encrypts the PIN for data security. The encrypted data is sent, in most cases, via a modem through specialized phone lines (leased lines that have a permanent connection) to a transaction-switching network where it is “switched” through the card issuer bank's host computer to obtain bank authorization for the card transaction. At the host's end, the PIN is decrypted and compared to the cardholder's recorded PIN to verify the cardholder's identity.

Existing PIN pads come in handheld and countertop models. Hence, they are restricted only to EFTPOS terminals. Because of this limitation, remote card-based payments (when the customer is in a geographically different location and does not have access to a standard EFTPOS terminal) cannot be made without changing the existing payment architecture. In present times, wireless transactions such as wireless funds transfers are gaining increasing popularity. People prefer to make payments for goods or services purchased by them while they are on the move, through their mobile devices such as their mobile phones. However, extending the PIN pad functionality to mobile devices in order to enable remote card-based payments is a challenge.

European patent publication EP1341136A2, titled “A method for processing transactions by means of wireless devices”, describes a system and a method for conducting wireless transactions. The described system comprises a mobile phone incorporating a SIM card on which customer information is stored. This information is activated and transferred to a transaction partner when customer PIN is entered into the mobile phone.

German patent publication GB2384098A, titled “A Payment System”, describes a payment system comprising account details stored in a SIM card of a cellular network device such as a mobile telephone. Upon connection of the cellular network device with a payment terminal and on correct entry of a code such as a PIN into the cellular device, it passes the account details to the payment terminal for crediting or debiting the account.

WIPO Patent publication WO0241271A1, titled “Electronic payment and associated systems”, describes an electronic payment system using a mobile telephony system's message service capacity combined with payment clearance systems, such as those operated by banks and credit card companies. The system requires a user to enter a correct PIN into a mobile phone to validate a transaction with the payment clearance system.

WIPO Patent publication WO03083793A3, titled “System and method for secure credit and debit card transactions” describes a method and a system for conducting secure credit and debit card transactions between a customer and a merchant. The system requires a customer to enter a correct PIN and transaction amount into a mobile phone to validate a transaction with a host computer. A SIM card embedded in the mobile phone encrypts the PIN and other customer information and sends it to a merchant mobile phone, which in turn, sends the encrypted information along with a check code to the host computer for authorization.

There are certain limitations associated with the use of the above-mentioned methods and systems. These methods and systems require changes to be made to the existing bank backend and security infrastructures. Further, the above-mentioned methods and systems use a SIM resident program to store user information and facilitate PIN entry for making mobile payments. This method is not analogous to using a physical PIN pad. Further, these systems also alter the manner in which the transaction is conducted. Hence, they do not facilitate payments using mobile devices in exactly the same manner as making payments at EFTPOS terminals using an account identifier card.

Hence, there exists a need for a method and a system that can be used to make payments through mobile devices by seamlessly integrating with the existing bank backend and security infrastructures. The method and system should also be easy to use for mobile users, and should emulate the physical PIN pad system. Further, the system should allow the bank to send personalized messages like ads, promotions, new offers etc, in additions to the transaction details that are sent to the mobile user.

### SUMMARY

The present invention provides a system, a method and a computer program product for enabling customers to make payments through their mobile devices for goods and services purchased by them. The system and method for making mobile payments, as described by the present invention, can be seamlessly integrated with the existing infrastructure.

In accordance with one aspect of the present invention, a system for making payments via a mobile device is provided. The system comprises a Virtual PIN pad that is provisioned in the users mobile device and allows a customer to enter a Personal Identification Number (PIN) to authorize payment to a merchant, from whom the customer purchases some goods or services. The system also comprises a transaction backend module connecting the Virtual PIN pad to a payment institution through a secure channel. The transaction backend module provisions the Virtual PIN pad and enables the payment by securely transferring the entered PIN from the Virtual PIN pad to the payment institution. The transaction backend module also securely transfers a payment authorization code to the Virtual PIN pad.

In accordance with another aspect, the present invention also provides four different methods for making payments using mobile devices, based on four different usage scenarios. The four usage scenarios relate to online payments; remote payments where the merchant generates a pay order and the customer makes a payment remotely without having access to a conventional EFTPOS; proximity payments, where the customer makes the payment to a merchant while being physically present in proximity to the merchant; payments using a mobile device for good and services for which a voice-based order is placed by the customer.

The first method corresponds to an online payment usage scenario where the payment is made using at least one mobile device that is being used by a customer. The mobile device comprises an embedded Virtual PIN pad and the payment is made by the customer to a merchant's online portal, which generates a pay order. The method comprises the steps of: selecting an item for purchase from the merchant's online portal; sending a pay order from the merchant's online portal to the mobile device of the customer though the transaction backend; entering a Personal Identification number (PIN) into the Virtual PIN pad; encrypting the PIN entered by the customer; sending the encrypted PIN from the Virtual PIN pad to a payment institution through the transaction backend; verifying the encrypted PIN for authorizing the payment; and approving or rejecting the transaction based on the verification.

A second method corresponds to a usage scenario where the payment is made using at least one mobile device that is being used by a customer. The customer is present in close proximity to the merchant. The customer's mobile device has access to a network that connects it to the transaction backend like GPRS or a 3-G connection. The customer's mobile device comprises an embedded Virtual PIN pad. The method comprises the steps of: entering a pay order into a transfer device being used by a merchant; sending the pay order from the transfer device to a transaction backend; sending the pay order from the transaction backend to the Virtual PIN pad; entering a Personal Identification number (PIN) into the Virtual PIN pad; sending the encrypted PIN from the Virtual PIN pad to the transaction backend; sending the encrypted PIN from the transaction backend to a payment institution; verifying the encrypted PIN; and approving or rejecting the transaction based on the verification.

A third method corresponds to a usage scenario where the payment is made using a first mobile device being used by a merchant and a second mobile device being used by a customer. In this case, the customer's mobile device does not have access to a network that connects it to the transaction backend. The customer's mobile device can connect to the merchant's mobile device using a technology such as Infrared or Bluetooth. The second mobile device being used by the customer comprises an embedded Virtual PIN pad. The method comprises the steps of: entering a pay order comprising a payment amount into the first mobile device; sending the entered pay order from the first mobile device to the Virtual PIN pad integrated with the second mobile device using a technology such as Infrared or Bluetooth; entering a Personal Identification number (PIN) into the Virtual PIN pad integrated with the second mobile device by the customer; encrypting the PIN entered by the customer; sending the encrypted PIN from the second mobile device being used by the customer to the first mobile device being used by the merchant using a technology such as Infrared or Bluetooth, and then sending the encrypted PIN to a payment institution through a transaction backend by the first mobile device being used by the merchant; verifying the encrypted PIN; and approving or rejecting the transaction based on the verification.

A fourth method corresponds to a usage scenario where a voice-based order is placed by the customer, and a payment is made for the same using a mobile device. The customer places a voice-based order with a merchant for purchasing a set of goods and/or services. The customer's mobile device has access to a network that connects it to the transaction backend. The customer's mobile device comprises an embedded Virtual PIN pad. The method comprises the steps of: placing a voice-based order with a merchant and submitting a Customer ID associated with the customer; generating a pay order and sending it to a transaction backend; sending the pay order from the transaction backend to the Virtual PIN pad; entering a Personal Identification number (PIN) into the Virtual PIN pad; sending the encrypted PIN from the Virtual PIN pad to the transaction backend; sending the encrypted PIN from the transaction backend to a payment institution; verifying the encrypted PIN; and approving or rejecting the transaction based on the verification.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 illustrates the environment, in which the system of the present invention works, in accordance with one embodiment of the present invention.

FIG. 2 describes the process of provisioning a Virtual PIN pad on a customer's mobile device, in accordance with one embodiment of the present invention.

FIG. 3 describes a method for making payments using a mobile device, wherein a customer makes a payment to a merchant's online portal, in accordance with one embodiment of the present invention.

FIG. 4 describes a method for making payments using a mobile device, wherein the customer places a voice-based order with a merchant and makes the payment using a mobile device, the mobile device having access to a network that connects the customer's mobile device to the transaction backend module, in accordance with one embodiment of the present invention.

FIG. 5 describes a method for making payments using a mobile device, wherein the customer makes the payment to a merchant through the mobile device, the mobile device having access to a network that connects it to the transaction backend module, in accordance with one embodiment of the present invention.

FIG. 6 describes a method for making payments using a secure connection between a customer's mobile device and a merchant's mobile device, wherein the customer's mobile device does not has access to a network that connects the customer's mobile device to the transaction backend module, in accordance with one embodiment of the present invention.

### DESCRIPTION OF PREFERRED EMBODIMENTS

The present invention provides a system and a method for enabling customers to make payments through their mobile devices for goods and services purchased by them.

In accordance with one embodiment of the present invention, a customer makes a payment to a merchant through a mobile device using an account identifier card. An account identifier comprises a debit card, a credit card or any other card that needs a valid secret code like a Personal Identification Number (PIN) or any other token for account validation and payment authorization. The customer authorizes the transfer of the payment amount to the merchant by transferring the PIN to a payment institution such as a bank via the mobile device.

The system and method provided by the present invention can be used to make remote as well as proximity payments using mobile devices. Remote payments are the payments made by a customer who is geographically separated from a merchant to whom the payment is being made. Proximity payments are the payments that are made by a customer who is present at the merchant's location while making the payment.

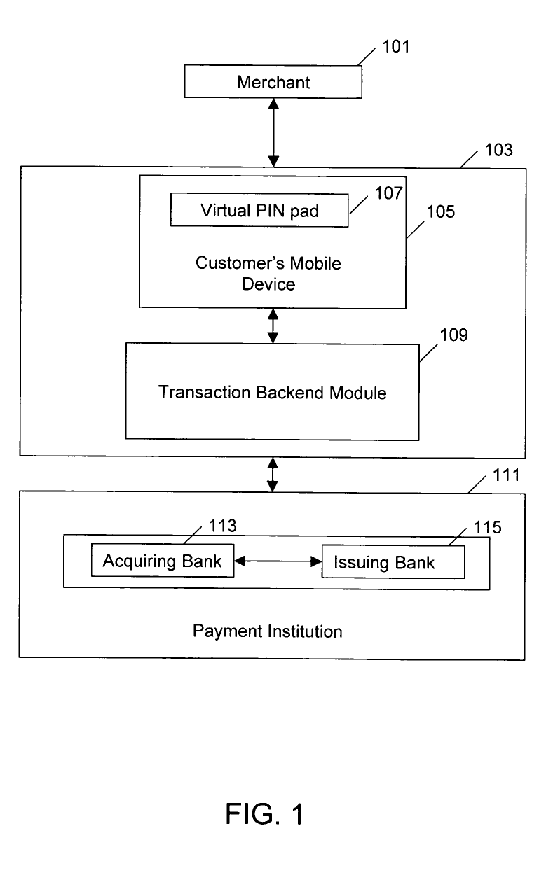

FIG.1 illustrates the environment, in which the system for making mobile payments using a mobile device works, in accordance with one embodiment of the present invention.

The environment, in which the system for making mobile payments using a mobile device works, comprises a merchant 101 and a system 103. System 103 comprises a customer's mobile device 105 that has a PIN pad 107 integrated with it, and a transaction backend module 109. PIN pad 107 is a PIN Entry Device (PED), through which a cardholder enters a PIN to authorize a card transaction. A card transaction is a transaction that involves making a payment using an account identifier card having a valid PIN. The authorization or rejection of a card transaction is done by a payment institution 111, which is connected to transaction backend module 109 through a network. Customer's mobile device 105 can be a mobile phone, a PDA or another type of mobile device that can connect to the network and exchange data with other entities connected to the network. The network can be a wired network, a wireless network or a combination of wired and wireless networks, using which customer's mobile device 109 and payment institution 111 are connected to transaction backend network 109.

According to one embodiment of the present invention, PIN pad 107 is a Virtual PIN pad. A Virtual PIN pad is software emulation of a PIN pad on a mobile device. In accordance with one embodiment of the present invention, Virtual PIN pad 107 is a secure PIN-entry system developed using Java, Symbian or other similar platform and is integrated with the handset of customer's mobile device 105. Virtual PIN pad 107 allows customers to key in their PINs in privacy. According to one embodiment of the present invention, Virtual PIN pad 107 is a software module that resides within the customer's mobile device 105. Its application logic emulates a physical EFTPOS PIN pad. Virtual PIN pad 107 encrypts the PIN entered by the customer and makes a secure connection to transaction backend module 109 for PIN verification. In accordance with one embodiment of the present invention, the secure connection is a Secure Socket Layer (SSL) connection over TCP-IP.

Virtual PIN pad 107 enables customers to read any information sent by merchant 101 or transaction backend module 109 via a graphical user interface (GUI). The GUI is a user-friendly interface. It displays the pay order containing the transaction details and allows the customers to read the sent information conveniently. The GUI presents the customer with a set of options using which the customer can respond to the sent information. The GUI also enables the customers to view their card transaction history. In one embodiment of the present invention, the card transaction history of a customer comprises details of all card transactions made by the customer using Virtual PIN pad 107. Details of a card transaction comprise information such as, transaction date, transaction amount and merchant identification. Virtual PIN pad 107 also stores details of the account identifier cards such as the type of account represented by the card.

According to one embodiment of the present invention, Virtual PIN pad 107 uses triple Data Encryption Standard (DES) technique for encrypting the entered PIN and maintaining its security. The encryption is performed using an identity key issued by payment institution 111 when Virtual PIN pad 107 is activated.

DES operates on blocks of 64 bits using a secret key that is 56 bits long. Triple-DES (TDES or 3DES) is a variant of DES. It uses a longer key for encryption and is more secure. Triple-DES uses three 56-bit DES keys, giving a total key length of 168 bits. Encryption of the entered PIN using Triple-DES involves: (i) encryption using DES with the first 56-bits of the identity key; (ii) decryption using DES with the second 56-bits of the identity key; and (iii) encryption using DES with the third 56-bits of the identity key. Decryption of the entered PIN using Triple-DES involves following the encryption steps in a reverse order.

According to one embodiment of the present invention, Virtual PIN pad 107 transmits the encrypted PIN over a secure Transport Layer Security (TLS) channel to transaction backend module 109 for PIN verification. The purpose of the TLS protocol is to provide encryption and certification at the transport layer, so that data can flow through a secure channel without requiring significant changes to existing client and server applications.

Transaction backend module 109 connects a payment institution 111 to Virtual PIN pad 107. Virtual PIN pad 107 exchanges transaction-specific information with payment institution 111 in a secure manner through transaction backend module 109 for completing a transaction.

Payment institution 111 can be a bank or any other credit institution facilitating the transfer of the payment amount from the customer to the merchant. According to one embodiment of the present invention, payment institution 111 comprises an acquiring bank 113 and an issuing bank 115. Acquiring bank 113 deals with merchants who accept payment for goods and services sold by them through account identifier cards. The merchants have an account with this bank and deposit the value of each day's sales using account identifier cards with this bank. Acquiring bank 113 buys (acquires) the merchant's sales slips and credits the sales value to the merchant's account. Issuing bank 115 or the cardholder's (customer's) bank extends credit to customers through account identifier card accounts. The bank issues account identifier cards to customers and receives their payment at the end of the billing period. Merchants receive the payments made by customers using the account identifier cards as a result of settlement of funds between acquiring bank 113 and issuing bank 115.

Transaction backend module 109 transfers the encrypted PIN to payment institution 111 for verification over a secure channel. It also transfers information such as merchant and customer identification codes, payment authorization codes, payment refusal intimations and other advertising or sales promotion messages from payment institution 111 to Virtual PIN pad 107.

According to one embodiment of the present invention, 3-D Secure authentication system is used for the secure transfer of information between payment institution 111 and transaction backend module 109. 3-D Secure is a protocol developed by Visa and MasterCard, which enables secure card transactions over the Internet. According to the 3-D Secure model, a card issuing authority is entirely responsible for authenticating its cardholders, thereby, allowing greater security and increased traceability of the card transactions. The primary benefit of 3D-Secure Authentication is the shift of liability from the merchant to the card issuing authority or the cardholder (customer) on online card transactions. In a standard online card transaction, when the card-holder or the card issuing authority disputes a transaction (as being a fraudulent), then the merchant is liable to pay back the disputed charges. However, if the merchant has attempted a 3D-Secure Authentication for the card transaction, then the liability of the transaction is with the cardholder.

The integrity of the authentication requests and responses exchanged between payment institution 111 and transaction backend module 109 is maintained by digitally signing the exchanged information. The validation of the signatures on the exchanged information is done using a certificate, which is sent along with the digitally signed information. The certificate is issued to transaction backend module 109 by a certificate authority such as Verisign™.

Hence, the system of making payments via a mobile device, as described in the present invention, does not involve any change in existing backend infrastructure comprising acquirer bank 113 and issuing bank 115. The system of the present invention handles only the security of the mobile channel. Any data relating to the card transaction is not altered.

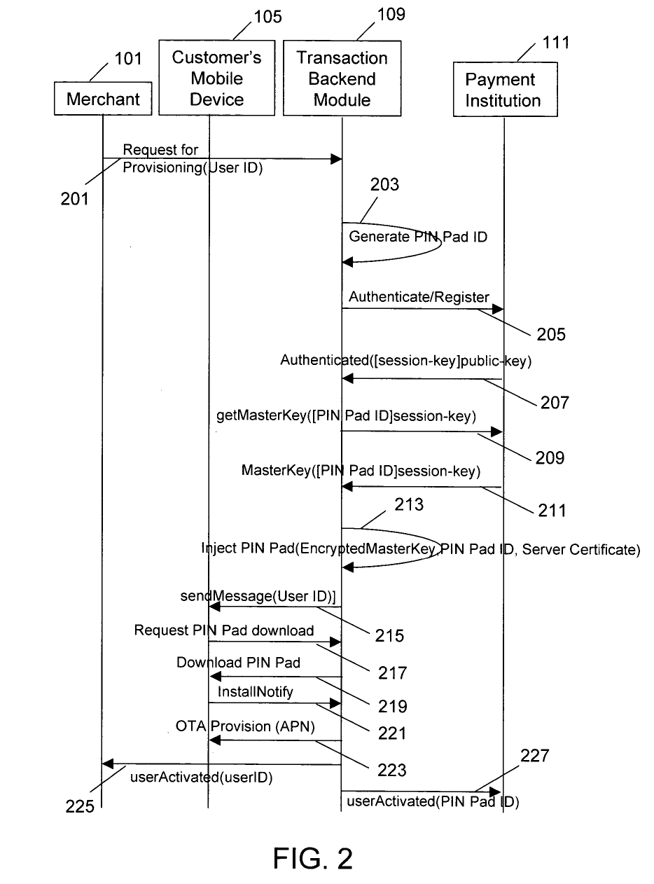

In order to use a Virtual PIN pad on a mobile device, the Virtual PIN pad first needs to be provisioned on the mobile device. Provisioning of a Virtual PIN pad on a mobile device comprises the download of the Virtual PIN pad on the mobile device and its installation and configuration, in order to make it user-ready for making payments. FIG. 2 describes the process of provisioning a Virtual PIN pad on a customer's mobile device, in accordance with one embodiment of the present invention.

Virtual PIN pad 107 can be provisioned on mobile device 105 in an easy and secure manner. Provisioning of Virtual PIN pad 107 on mobile device 105 involves download and installation of Virtual PIN pad 107 on customer mobile device 105. According to one embodiment of the present invention, Virtual PIN pad 107 is provisioned on customer mobile device 105 when at step 201, customer mobile device 105 sends a request for provisioning. In one embodiment of the present invention, the request can be sent using the SMS or MMS service of a mobile network. However, it will be apparent to a person skilled in the art that other communication services can also be used in the process of provisioning Virtual PIN pad 107 on customer mobile device 105.

Virtual PIN pad 107 can be pre-installed in mobile device 105, or it may need to be installed in mobile device 105 by the user. In case Virtual PIN pad 107 needs to be installed in a mobile device that does not have a pre-installed Virtual PIN pad 107, the mobile device should be compliant with the standards that are required for installing Virtual PIN pad 107. The two standard requirements that are required in such a mobile device are (i) the mobile device should have suitable network connectivity, and (ii) the mobile device should be able to provide an environment and the requisite resources for Virtual PIN pad 107 (which is a software application) to execute its functionalities.

For example, in one embodiment of the present invention, Virtual PIN pad 107 is a java (J2ME) application that can be downloaded and installed on mobile device 105. In this embodiment, in order to allow installation of this java application, mobile device 105 should be J2ME compliant and should have a GPRS/3G connectivity.

Virtual PIN pad 107 is provisioned through transaction backend module 109. At step 203, transaction backend module 109 generates a unique PIN pad identification code (PIN pad ID) for each Virtual PIN pad it provisions on a mobile device. At step 205, transaction backend module sends the PIN pad ID to payment institution 111 for authentication and registration. If the PIN pad ID corresponding to Virtual Pin pad 107 is authenticated and registered, then at step 207, payment institution 111 sends an authentication approval to transaction backend module 109. Next, at step 209, transaction backend module 109 sends a request for a master key to payment institution 111. At step 211, payment institution 111 sends the master key corresponding to the newly registered PIN pad ID to transaction backend module 109 over a secure channel.

Alternatively, in another embodiment of the present invention, the PIN pad ID as well as the master key is generated by payment institution 111 and directly attached to the Virtual PIN pad.

Transaction backend module 109 encrypts the received PIN pad ID. At step 213, transaction backend module 109 attaches the encrypted master key and a server certificate to Virtual PIN pad 107 whose PIN pad ID has been registered. On the other hand, if the PIN pad ID is not registered, it is invalidated by payment institution 111 as well as by transaction backend module 109.

At step 215, transaction backend module 109 sends a message to customer mobile device 105 regarding the availability of Virtual PIN pad 107 for download. At step 217, customer mobile device 105 sends a request for downloading Virtual PIN pad 107 to transaction backend module 109. At step 219, Virtual PIN pad 107 is downloaded on customer mobile device 105. After Virtual PIN pad 107 is successfully downloaded and installed, customer mobile device 105, at step 221, sends an install notification to transaction backend module 109.

Next, transaction backend module 109 checks whether any data access resource is present on customer mobile device 105. If customer mobile device 105 does not posses any data access resource, then at step 223, transaction backend module 109 associates a data access resource such as Access Point Name (APN) with customer mobile device 105. APN is a standard data access resource used in mobile billing environments. It functions as a network identifier and identifies the access points to an external network.

At step 225, transaction backend module 109 sends a user identification code (User ID) to merchant 101 for identifying customer mobile device 105 on which Virtual PIN pad 107 has been provisioned. At step 227, transaction backend module 109 sends the PIN Pad ID to payment institution 111 for identifying the provisioned Virtual PIN pad 107.

After Virtual PIN pad 107 is installed on customer mobile device 105, the user can configure Virtual PIN pad 107 for making payments through mobile device 105. In one embodiment of the present invention, each customer who uses the Virtual PIN pad application is assigned a unique identifier Customer ID (CID) and a password in numeric/alphanumeric password.

In one embodiment of the present invention, the CID is in alphanumeric format. For security reasons, the Customer ID does not bear any relation with the number or PIN of the account identifier card that the customer intends to use for making payments using mobile device 105. The customer uses the CID and password to store and update his/her personal profile in transaction backend module 109. Using this profile, merchant 101 can track the customers to whom the merchant should send product/service related information and the associated pay orders. The customer can register one or more than one account identifier cards for making payments through Virtual PIN pad 107. If the customer has registered multiple account identifier cards for making payments, the customer can choose the appropriate account identifier card at the time of making the payment. This can be done by using the user interface provided by Virtual PIN pad 107. After selecting an appropriate account identifier card, the user can enter the corresponding PIN associated with the selected account identifier card. Virtual PIN pad 107 then encrypts the entered PIN and sends it to transaction module 109 in order to process the transaction through payment institution 111.

When the customer opens Virtual PIN pad 107 on mobile device 105 to make a payment, the Virtual PIN pad starts an authentication process with transaction backend module 109. After a successful authentication, transaction backend module sends a key encrypting key [master key encrypting key] for decrypting the master key. Once the master key is decrypted successfully, the payment order sent by the merchant is pushed to Virtual PIN pad 107.

The manner in which transaction backend module 109 handles the card transaction depends on the usage scenario. A usage scenario describes the manner in which a customer interacts with a merchant in order to make a payment for a purchase. The customer can make a payment for goods or services purchased from the merchant's online portal, using a mobile device. Furthermore, the customer can make a payment to the merchant using a mobile device, while being present at the merchant's location, and having access to a network such as a GPRS network that connects the customer's mobile device to transaction backend module 109. The customer can also make a payment to the merchant using a mobile device while being present at a merchant's location, and not having access to a network that connects the customer's mobile device to transaction backend module 109. In this case, the customer connects to a merchant via a connection such as Infrared or Bluetooth between customer's mobile device 105 and a merchant's mobile device. The customer can also place a voice-based order for goods/services with merchant 101 and then make the payment using mobile device 105. In all these cases, the merchant generates a pay order, which is delivered to Virtual PIN pad 107 integrated in customer mobile device 105. The pay order comprises the merchant ID provided to merchant 101 at the time of authentication by transaction backend module 109, a payment amount and other information describing the good or service to be purchased by a customer.

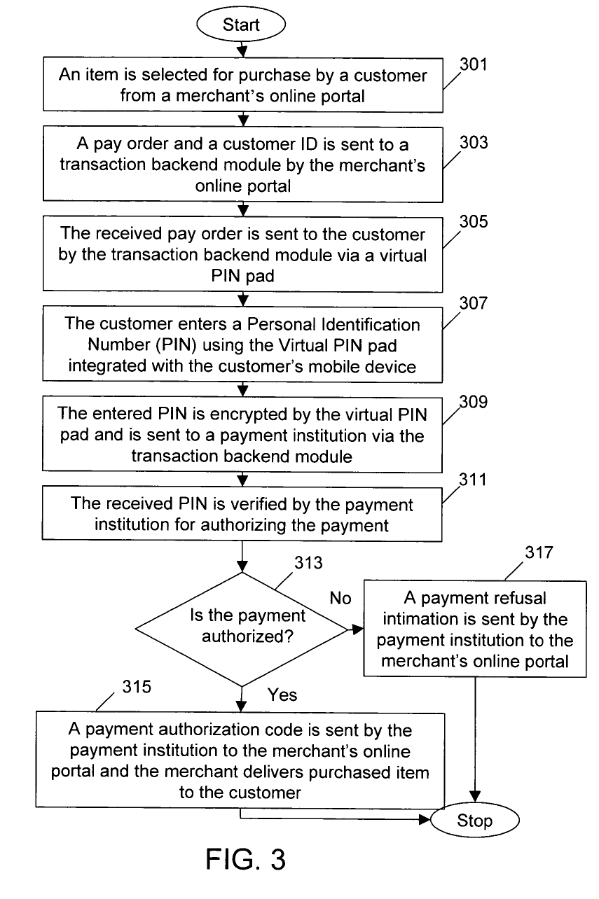

The method of making payments via mobile devices in each of these four usage scenarios is described herein with reference to FIG. 3, 4, 5 and 6.

In all the four usage scenarios, a merchant as well as a customer is authenticated by transaction backend module 109 and provided with a merchant identification code (merchant ID or MID) and a customer identification code (customer ID or CID) respectively, prior to the commencement of a card transaction, for making payments using a mobile device.

The first usage scenario relates to remote payment method where a customer purchases goods or services from a merchant's online portal and pays for them using a mobile device. The customer accesses the merchant's online portal through an online electronic network such as the Internet or a mobile network based on protocols such as WAP. The method of making payments in this usage scenario is described with reference to FIG. 3.

FIG. 3 describes a method for making payments using a mobile device, wherein a customer makes a payment to a merchant's online portal, in accordance with one embodiment of the present invention.

At step 301, a customer visits a merchant's online portal and selects an item displayed on the portal for purchase. Next, the customer selects the option of paying for the purchased item using an account identifier card such as a debit card, from a list of payment options available on the portal. The online portal belonging to merchant 101 presents a web page to the customer for capturing a unique customer identification code (customer ID). The customer ID is a unique code such as an email address or a user alias for uniquely identifying the customer.

At step 303, the online portal sends the captured customer ID and a pay order to transaction backend module 109. The pay order comprises the merchant ID provided to merchant 101 at the time of authentication by transaction backend module 109, the payment amount and other information describing the item selected by the customer.

Once merchant 101 is correctly authenticated, then at step 305, transaction backend module 109 sends the pay order to Virtual PIN pad 107 integrated with customer's mobile device 105. According to one embodiment of the present invention, the pay order is received by the customer's mobile device via an SMS or MMS service of a mobile network.

Upon accepting the payment for the amount mentioned in the pay order the customer selects an account identifier card from a list of account identifier cards.

Then, at step 307, the customer keys in a corresponding PIN into customer's mobile device 105, in order to authorize the payment to merchant 101. According to one embodiment of the present invention the account identifier card is a debit card having a valid PIN.

At step 309, the entered PIN is encrypted and sent to payment institution 111 through transaction backend module 109 for verification, in order to authorize the payment. According to one embodiment of the present invention, Virtual PIN pad 107 encrypts the entered PIN using triple DES encryption technique and transmits it over a secure Transport Layer Security (TLS) channel to transaction backend module 109. Transaction backend module 109, in turn, transmits the encrypted PIN over a secure channel to payment institution 111. According to one embodiment of the present invention, 3-D Secure authentication system is used for the secure transfer of information between payment institution 111 and transaction backend module 109.

At step 311, payment institution 111 decrypts the PIN and verifies it in order to authorize the payment. According to one embodiment of the present invention, payment institution 111 comprises acquiring bank 113 and issuing bank 115. Acquiring bank 113 submits the PIN to issuing bank 115 for verification and payment authorization. The interaction between acquiring bank 113 and issuing bank 115 in this case, is similar to the interaction between them in the case where a customer makes a card transaction at a merchant's location via a standard desktop PIN pad. If the payment is authorized by issuing bank 115 at step 311, a payment authorization code is sent to acquiring bank 113. Also, at step 315 the payment authorization code is sent over a secure channel to the online portal belonging to merchant 101 via transaction backend module 109. However, if the payment is not authorized at step 313, then at step 317, a payment refusal intimation is sent to the online portal belonging to merchant 101 via transaction backend module 109. If the online portal receives a payment authorization code, merchant 101 delivers the purchased item to the customer.

It will be apparent to a person skilled in the art that the method of making payments using mobile devices described in the present invention remains unaffected, even if the manner of interaction between different entities of payment institution 111 is altered.

According to one embodiment of the present invention, an exemplary pay order sent to customer's mobile device 105, by transaction backend module 109 appears as follows:

TID: 11370220

MID: 44228013548564

Pay $155.50 to download Space Invaders?

Enter PIN: xxxx

Where “MID” is the merchant identification code generated by transaction backend module 109 at the time of the merchant's registration with it. “TID” is a transaction identification code generated by transaction backend module 109 for uniquely identifying each payment.

An exemplary payment authorization information sent to the online portal by the payment institution 111 through transaction backend module 109, after the authorization of a payment appears as follows:

Customer ID: 548658669423

TID: 11370240

Transaction Approved

Auth CODE: 449834

Where “Auth CODE” is the payment authorization code.

It will be apparent to a person skilled in the art that the representations of the pay order and the payment authorization/refusal information shown above are simply for exemplary purposes. The pay order and the payment authorization/refusal information can be presented to the user in different ways, in addition to the ones shown above. Further, the graphic user interface of the Virtual PIN pad integrated with the customer's mobile device can be customized by the customer, in order to present the pay order and payment authorization/refusal information in a user-defined format.

It will also be apparent to a person skilled in the art that the method of making payments using mobile devices described in the present invention remains unaffected, even if the content and format of the information contained in the pay order as well as the information sent to the online portal by the payment institution 111 after the authorization of a payment, is altered. The pay order and payment authorization/refusal confirmation can also include additional information in addition to the information shown in the exemplary representations above, or exclude certain information from the exemplary representations shown above.

According to one embodiment of the invention, the integrity of the authentication requests and responses exchanged between payment institution 111 and transaction backend module 109 is maintained by digitally signing the exchanged information. The validation of the signatures on the exchanged information is done using a certificate, which is sent along with the digitally signed information. The certificate is issued to transaction backend module 109 by a certificate authority such as Verisign™.

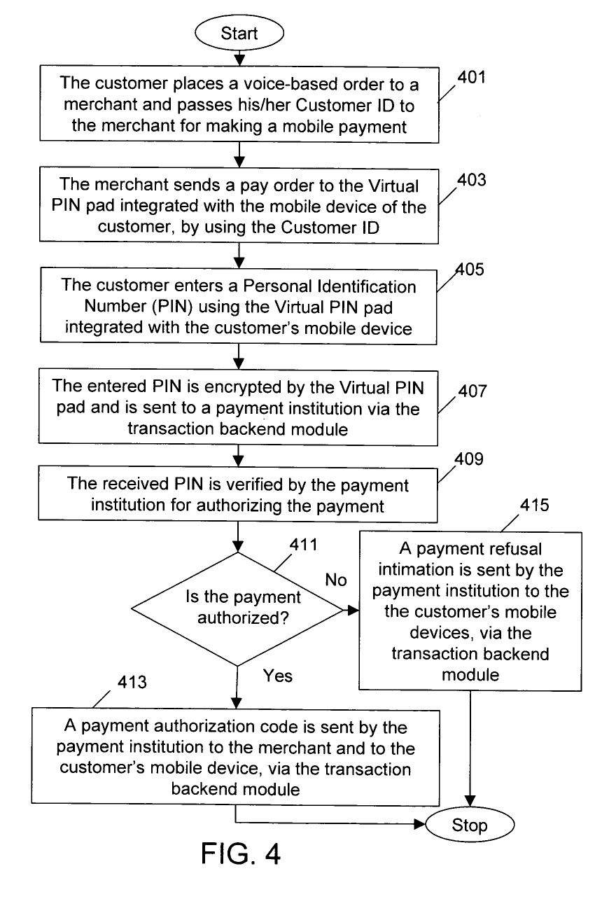

A second possible usage scenario relates to a situation where a customer makes a payment to a merchant using a mobile device, while being present at the merchant's location and having access to a network such as GPRS connecting to transaction backend module 109. The method for making a payment using a mobile phone in this usage scenario is described with reference to FIG. 4.

The second usage scenario relates to a situation where the customer places a voice-based order with a merchant, and then pays for the ordered goods/services using a mobile device. In this usage scenario, the mobile device has a Virtual PIN pad integrated with it. The method steps involved in the process for making the payments in this usage scenario are described below with reference to FIG. 4.

At step 401, the customer places a voice-based order for goods/services with merchant 101. A voice-based order may involve placing an order to a merchant through vocal communication, or using an automated voice response system available at the end of merchant 101 for receiving the order. After placing the order, the customer provides merchant 101 with a unique Customer ID (CID) that is assigned to the customer at the time of registering Virtual PIN pad 107 (integrated with customer's mobile device 105) with transaction backend module 109. The order may be placed using customer mobile device 105 or through other means of communication between the consumer and the merchant. For example, a customer may place an order for a pizza with a merchant outlet using his/her mobile device, through a landline, using an automated voice response system or through verbal agreement between the customer and merchant outlet. In such an exemplary transaction, the customer can place the voice-based order and inform the merchant outlet about his/her CID. The CID can be verbally communicated to the merchant outlet. Alternatively, it can be keyed in using the communication device being used by the customer, and processed automatically by an automated transaction processing system at the merchant outlet. At step 403, merchant 101 generates a pay order for the goods and services purchased by the customer through the voice-based order. The pay order comprises the merchant ID provided to merchant 101 at the time of registration with transaction backend module 109, the payment amount and other information describing the good or service to be purchased by a customer. Merchant 101 enters the pay order on a transfer device such as a computer or a mobile device, which in turn sends the entered pay order to transaction backend module 109 using an electronic network. An electronic network can be a wired network, a wireless network or a combination of the two networks. Examples of electronic network comprise the Internet, wi-fi, and mobile networks such as 2.5G, 3G and next Gen networks. Transaction backend module 109 authenticates merchant 101 by verifying the merchant ID provided with the pay order.

Once merchant 101 is correctly authenticated then at step 403, transaction backend module 109 further sends the pay order to customer's mobile device 105. According to one embodiment of the present invention, merchant 101 provides a customer ID to transaction backend module 109 and directs it to send the pay order to Virtual PIN pad associated with the customer ID that is provided while placing the voice-based order. Transaction backend module 109 sends the pay order to the customer via Virtual PIN pad 107 integrated with customer's mobile device 105 using an electronic network such as GPRS network. According to one embodiment of the present invention, the pay order is received by the customer mobile device 105 via an SMS or MMS service of a mobile network.

Upon accepting the payment for the amount mentioned in the pay order the customer selects an account identifier card from a list of account identifier cards. Then, at step 405, the customer keys in a corresponding PIN into customer's mobile device 105, in order to authorize the payment to merchant 101. According to one embodiment of the present invention the account identifier card is a debit card having a valid PIN.

At step 407, the entered PIN is encrypted and sent to payment institution 111 through transaction backend module 109 for verification, in order to authorize the payment. According to one embodiment of the present invention, Virtual PIN pad 107 encrypts the entered PIN using triple DES encryption technique and transmits it over a secure Transport Layer Security (TLS) channel to transaction backend module 109 for PIN verification. Transaction backend module 109 in turn transmits the encrypted PIN over a secure channel to payment institution 111. According to one embodiment of the present invention, 3-D Secure authentication system is used for the secure transfer of information between payment institution 111 and transaction backend module 109.

At step 409, payment institution 111 decrypts the PIN and verifies it in order to authorize the payment. According to one embodiment of the present invention, payment institution 111 comprises acquiring bank 113 and issuing bank 115. Acquiring bank 113 submits the PIN to issuing bank 115 for verification and payment authorization. The interaction between acquiring bank 113 and issuing bank 115, in this case, is similar to the interaction between them in the case where a customer makes a card transaction at a merchant's location via a standard desktop PIN pad. If the payment is authorized by issuing bank 115 at step 411, step 413 is performed. At step 413, a payment authorization code is sent to acquiring bank 113. Acquiring bank 113 then forwards the authorization code to the transaction backend system 109, which in turn sends it to merchant 101 and to Virtual pin pad 107 over a secure channel. However, if the payment is not authorized at step 413, then step 415 is performed. At step 415, a payment refusal intimation is sent to merchant 101 and to Virtual PIN pad 107 via transaction backend 109.

It will be apparent to a person skilled in the art that the method of making payments using mobile devices described in the present invention remains unaffected, even if the manner of interaction between different entities of payment institution 111 is altered.

According to one embodiment of the present invention, an exemplary payment authorization information sent to Virtual PIN pad 107 by transaction backend 109, after the payment has been authorized by payment institution 111, appears as follows:

MID: 44228013548564

CID: 11370240

TID: 11370240

Transaction approved for Satish G

Approval CODE: 449834

Where “MID” is the merchant identification code and “CID” is the customer identification code. These identification codes are generated by transaction backend module 109 at the time of the merchant's and the customer's registration with it. “TID” is a transaction identification code generated by transaction backend module 109 for uniquely identifying each payment. “Satish G” is the customer's name, which is obtained from payment institution 111 using the PIN provided by the customer.

An exemplary payment authorization information sent to merchant 101 by transaction backend 109, after the payment has been authorized by payment institution 111, appears as follows:

TID: 11370240

Transaction Approved.

Auth CODE: 449834

Where “Auth CODE” is a payment authorization code, which is the same as the “Approval CODE” sent to the customer.

It will be apparent to a person skilled in the art that the representations of the pay order and the payment authorization/refusal information shown above are simply for exemplary purposes. The pay order and the payment authorization/refusal information can be presented to the user in different ways, in addition to the ones shown above. Further, the graphic user interface of the Virtual PIN pad integrated with the customer's mobile device can be customized by the customer, in order to presenting the pay order and payment authorization/refusal information in a user-defined format.

It will also be apparent to a person skilled in the art that the method of making payments using mobile devices described in the present invention remains unaffected, even if the content and format of the information contained in the pay order as well as the information sent to the online portal by the payment institution 111 after the authorization of a payment, is altered. The pay order and payment authorization/refusal confirmation can also include additional information in addition to the information shown in the exemplary representations above, or exclude certain information from the exemplary representations shown above.

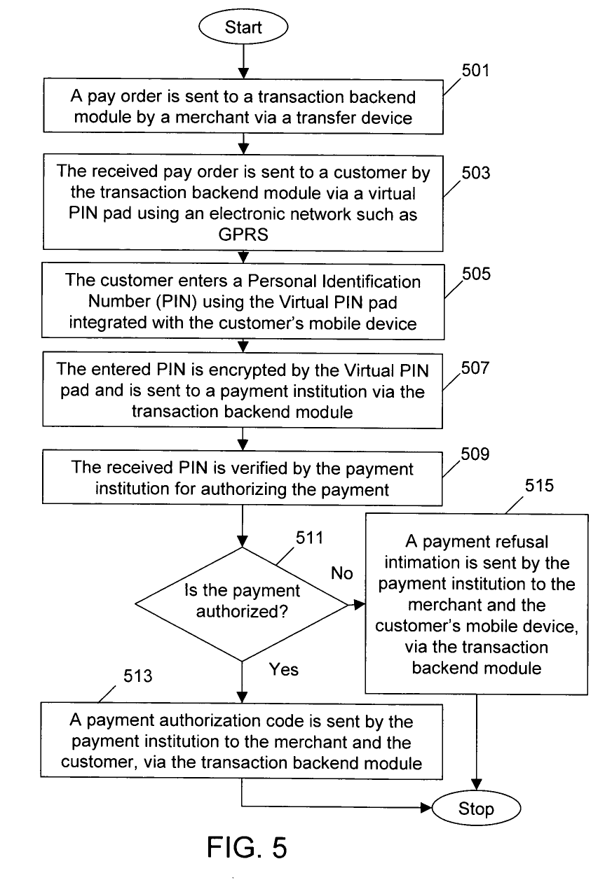

FIG. 5 describes a method for making payments using a mobile device in a third usage scenario, wherein the customer's mobile device has access to a network like GPRS that connects it to the transaction backend, in accordance with one embodiment of the present invention.

At step 501, merchant 101 sends a pay order to transaction backend module 109. The pay order comprises the merchant ID provided to merchant 101 at the time of authentication by transaction backend module 109, the payment amount and other information describing the good or service to be purchased by a customer. Merchant 101 enters the pay order on a transfer device such as a computer or a mobile device, which in turn sends the entered pay order to transaction backend module 109 using an electronic network. An electronic network can be a wired network, a wireless network or a combination of the two networks. Examples of electronic network comprise the Internet, wi-fi, and mobile networks such as 2.5G, 3G and next Gen networks. Transaction backend module 109 authenticates merchant 101 by verifying the merchant ID provided with the pay order.

Once merchant 101 is correctly authenticated then at step 503, transaction backend module 109 sends the pay order to customer's mobile device 105. According to one embodiment of the present invention, merchant 101 provides a customer ID to transaction backend module 109 and directs it to send the pay order to the customer whose ID is provided. According to another embodiment of the present invention, a customer is selected by the transaction backend module without any directions from merchant 101, in order to send the pay order. Transaction backend module 109 sends the pay order to the customer via Virtual PIN pad 107 integrated with customer's mobile device 105 using an electronic network such as GPRS network. According to one embodiment of the present invention, the pay order is received by the customer's mobile device via an SMS or MMS service of a mobile network.

Upon accepting the payment for the amount mentioned in the pay order the customer selects an account identifier card from a list of account identifier cards. Then, at step 505, the customer keys in a corresponding PIN into customer's mobile device 105, in order to authorize the payment to merchant 101. According to one embodiment of the present invention the account identifier card is a debit card having a valid PIN.

At step 507, the entered PIN is encrypted and sent to payment institution 111 through transaction backend module 109 for verification, in order to authorize the payment. According to one embodiment of the present invention, Virtual PIN pad 107 encrypts the entered PIN using triple DES encryption technique and transmits it over a secure Transport Layer Security (TLS) channel to transaction backend module 109 for PIN verification. Transaction backend module 109 in turn transmits the encrypted PIN over a secure channel to payment institution 111. According to one embodiment of the present invention, 3-D Secure authentication system is used for the secure transfer of information between payment institution 111 and transaction backend module 109.

At step 509, payment institution 111 decrypts the PIN and verifies it in order to authorize the payment. According to one embodiment of the present invention, payment institution 111 comprises acquiring bank 113 and issuing bank 115. Acquiring bank 113 submits the PIN to issuing bank 115 for verification and payment authorization. The interaction between acquiring bank 113 and issuing bank 115 in this case, is similar to the interaction between them in the case where a customer makes a card transaction at a merchant's location via a standard desktop PIN pad. If the payment is authorized by issuing bank 115 at step 511, step 513 is performed. At step 513, a payment authorization code is sent to acquiring bank 113. Also, at step 513, the payment authorization code is sent over a secure channel to merchant 101 and to Virtual PIN pad 107 via transaction backend module 109. However, if the payment is not authorized at step 513, then step 515 is performed. At step 515, a payment refusal intimation is sent to merchant 101 and to Virtual PIN pad 107 via transaction backend 109.

It will be apparent to a person skilled in the art that the method of making payments using mobile devices described in the present invention remains unaffected, even if the manner of interaction between different entities of payment institution 111 is altered.

According to one embodiment of the present invention, an exemplary payment authorization information sent to Virtual PIN pad 107 by transaction backend 109, after the payment has been authorized by payment institution 111, appears as follows:

MID: 44228013548564

CID: 11370240

TID: 11370240

Transaction approved for Satish G

Approval CODE: 449834

Where “MID” is the merchant identification code and “CID” is the customer identification code. These identification codes are generated by transaction backend module 109 at the time of the merchant's and the customer's registration with it. “TID” is a transaction identification code generated by transaction backend module 109 for uniquely identifying each payment. “Satish G” is the customer's name, which is obtained from payment institution 111 using the PIN provided by the customer.

An exemplary payment authorization information sent to merchant 101 by transaction backend 109, after the payment has been authorized by payment institution 111, appears as follows:

TID: 11370240

Transaction Approved.

Auth CODE: 449834

Where “Auth CODE” is a payment authorization code, which is the same as the “Approval CODE” sent to the customer.

It will be apparent to a person skilled in the art that the representations of the pay order and the payment authorization/refusal information shown above are simply for exemplary purposes. The pay order and the payment authorization/refusal information can be presented to the user in different ways, in addition to the ones shown above. Further, the graphic user interface of the Virtual PIN pad integrated with the customer's mobile device can be customized by the customer, in order to presenting the pay order and payment authorization/refusal information in a user-defined format.

It will also be apparent to a person skilled in the art that the method of making payments using mobile devices described in the present invention remains unaffected, even if the content and format of the information contained in the pay order as well as the information sent to the online portal by the payment institution 111 after the authorization of a payment, is altered. The pay order and payment authorization/refusal confirmation can also include additional information in addition to the information shown in the exemplary representations above, or exclude certain information from the exemplary representations shown above.

According to one embodiment of the invention, the integrity of the authentication requests and responses exchanged between payment institution 111 and transaction backend module 109 is maintained by digitally signing the exchanged information. The validation of the signatures on the exchanged information is done using a certificate, which is sent along with the digitally signed information. The certificate is issued to transaction backend module 109 by a certificate authority such as Verisign™.

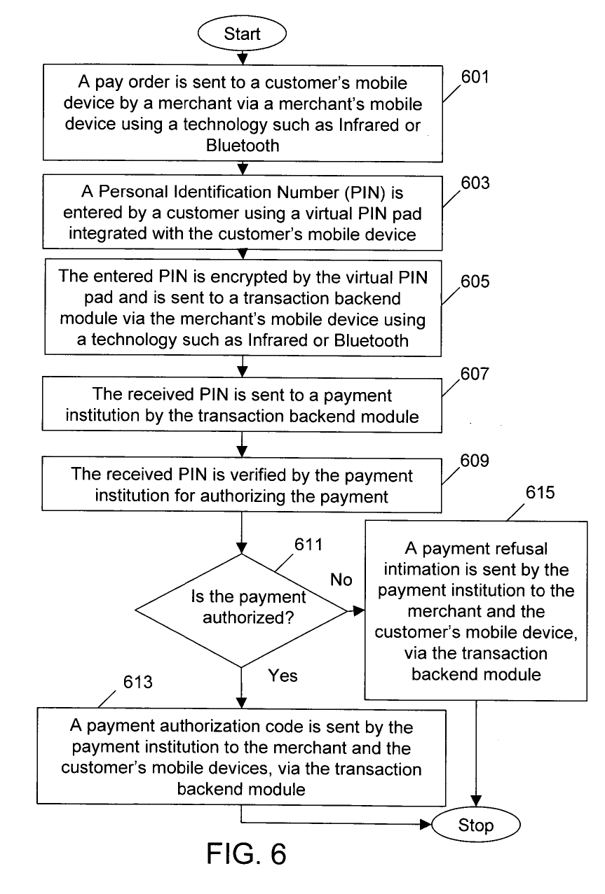

A fourth usage scenario relates to a situation where a customer purchases goods or services from a merchant, and pays for them through an interaction between a mobile device being used by merchant 101 and a customer's mobile device 105. The customer's mobile device does not have access to a network that connects it to transaction backend module 109. The method for making a payment using a mobile device in this usage scenario is described with reference to FIG. 6.

FIG. 6 describes a method for making payments using a secure connection between a customer's mobile device and a merchant's mobile device, wherein the customer's mobile device does not access to a network that connects it to the transaction backend module, in accordance with one embodiment of the present invention.

In this scenario, merchant 101 enters a pay order on a first mobile device, which functions as a point of sale (POS) terminal. The pay order comprises the merchant ID provided to merchant 101 at the time of authentication by transaction backend module 109, the payment amount and other information describing the good or service to be purchased by a customer. At step 601, the pay order entered by merchant 101 is sent to customer's mobile device 105, using the electronic network. According to one embodiment of the present invention, the pay order is sent from the mobile device being used by merchant 101 to customer's mobile device 105 using an Infrared or Bluetooth connection. Customer's mobile device 105 does not have access to a network such as GPRS network that connects it to transaction backend module 109. It will be apparent to a person skilled in the art that other technologies apart from Infrared and Bluetooth technology can also be used to send the pay order from the mobile device being used by merchant 101 to customer's mobile device 105. The customer obtains the pay order sent by merchant 101 through Virtual PIN pad 107 integrated with customer's mobile device 105. According to one embodiment of the present invention the pay order is received by the customer's mobile device via an SMS or MMS service of a mobile network.

Upon accepting the payment for the amount mentioned in the pay order the customer selects an account identifier card from a list of account identifier cards. Then at step 603, the customer keys in a corresponding PIN into customer's mobile device 105, in order to authorize the payment to merchant 101. According to one embodiment of the present invention, the account identifier card is a debit card having a valid PIN.

At step 605, the entered PIN is encrypted and sent to transaction backend module 109 via the mobile device being used by the merchant 101. According to one embodiment of the present invention Virtual PIN pad 107 sends the encrypted PIN to the mobile device being used by the merchant 101 using an Infrared or Bluetooth connection. The mobile device being used by the merchant 101, in turn transmits it to transaction backend module 109. According to one embodiment of the present invention, Virtual PIN pad 107 encrypts the entered PIN using triple DES encryption technique. The encrypted PIN is transmitted over a secure Transport Layer Security (TLS) channel to transaction backend module 109 by the mobile device being used by the merchant 101.

At step 607, transaction backend module 109 transmits the encrypted PIN over a secure channel to payment institution 111 for verification in order to authorize the payment. According to one embodiment of the present invention, 3-D Secure authentication system is used for the secure transfer of information between payment institution 111 and transaction backend module 109.

At step 609, payment institution 111 decrypts the PIN and verifies it in order to authorize the payment. According to one embodiment of the present invention, payment institution 111 comprises acquiring bank 113 and issuing bank 115. Acquiring bank 113 submits the PIN to issuing bank 115 for verification and payment authorization. The interaction between acquiring bank 113 and issuing bank 115 in this case, is similar to the interaction between them in the case where a customer makes a card transaction at a merchant's location via a standard desktop PIN pad. If the payment is authorized by issuing bank 115 at step 611, step 613 is performed. At step 613, a payment authorization code is sent by acquiring bank 113 to the mobile devices being used by the merchant. Also, at step 613, the payment authorization code is sent over a secure channel to Virtual PIN pad 107 integrated with customer's mobile device 105 via transaction backend module 109. According to one embodiment of the present invention, the payment authorization code is sent to Virtual PIN pad 107 using the SMS or MMS services of a mobile network. Virtual PIN pad 107 sends the payment authorization code to the mobile device being used by merchant 101. However, if the payment is not authorized at step 611, then step 615 is performed. At step 615, a payment refusal intimation is sent to Virtual PIN pad 107 integrated with customer's mobile device 105 via transaction backend module 109. According to one embodiment of the present invention, the payment refusal intimation is sent to Virtual PIN pad 107 using the SMS or MMS services of a mobile network.

It will be apparent to a person skilled in the art that in addition to SMS and MMS, other types of voice, text and multimedia data exchange services available in a mobile network can also be used for the purpose of exchanging the requisite information between the environmental components of the present invention.

Transaction backend network also sends payment refusal intimation to the mobile device being used by merchant 101. According to one embodiment of the present invention, Virtual PIN pad 107 sends the payment authorization code or the payment refusal intimation to the mobile device being used by merchant 101 using an Infrared or Bluetooth connection.

It will be apparent to a person skilled in the art that the method of making payments using mobile devices described in the present invention remains unaffected, even if the manner of interaction between different entities of payment institution 111 is altered.

According to one embodiment of the present invention, an exemplary payment authorization information sent to Virtual PIN pad 107 by transaction backend module 109, after the payment has been authorized by payment institution 111, appears as follows:

MID: 44228013548564

TID: 11370240

Transaction approved for James Brown.

Auth CODE: 449834

You account balance is xxxx.xx

Where “MID” is the merchant identification code generated by transaction backend module 109 at the time of the merchant's registration with it. “TID” is a transaction identification code generated by transaction backend module 109 for uniquely identifying each payment. “Auth CODE” is the payment authorization code. “James Brown” is the customer's name. Customer specific information such as name and the balance in the customer's account is obtained from payment institution 111 using the PIN provided by the customer.

An exemplary payment authorization information sent to the mobile device being used by merchant 101 by transaction backend module 109, via Virtual PIN pad 107 after the payment has been authorized by payment institution 111, appears as:

MID: 44228013548564

TID: 11370240

Transaction approved

Auth CODE: 449834

It will be apparent to a person skilled in the art that the representations of the pay order and the payment authorization/refusal information shown above are simply for exemplary purposes. The pay order and the payment authorization/refusal information can be presented to the user in different ways, in addition to the ones shown above. Further, the graphic user interface of the Virtual PIN pad integrated with the customer's mobile device can be customized by the customer, in order to presenting the pay order and payment authorization/refusal information in a user-defined format.

It will also be apparent to a person skilled in the art that the method of making payments using mobile devices described in the present invention remains unaffected, even if the content and format of the information contained in the pay order as well as the information sent to the online portal by the payment institution 111 after the authorization of a payment, is altered. The pay order and payment authorization/refusal confirmation can also include additional information in addition to the information shown in the exemplary representations above, or exclude certain information from the exemplary representations shown above.

According to one embodiment of the invention, the integrity of the authentication requests and responses exchanged between payment institution 111 and transaction backend module 109 is maintained by digitally signing the exchanged information. The validation of the signatures on the exchanged information is done using a certificate, which is sent along with the digitally signed information. The certificate is issued to transaction backend module 109 by a certificate authority such as Verisign™.

Using the system and method of the present invention, remote and proximity payments can be made using the same security and backend infrastructure that exists for making proximity payments.

Also, by using the system and method described in the present invention, payment institutions such as banks can send personalized messages to customers through Virtual PIN pads embedded in the customer's mobile device. These messages can be advertisements, sales promotion messages, new offers etc. Also, the secure integration between client and backend systems described in the present invention can be used by payment institutions to launch innovative cost effective services.

While the various embodiments of the invention have been illustrated and described, it will be clear that the present invention is not limited to these embodiments only. Numerous modifications, changes, variations, substitutions and equivalents will be apparent to those skilled in the art, without departing from the spirit and scope of the invention as described in the claims.

1. A system for making payments via a mobile device, the system comprising:
a. a Virtual PIN pad integrated with the mobile device, the Virtual PIN pad providing an interface for entering a Personal Identification Number (PIN), the PIN being entered by a customer in order to authorize a payment transaction; and
b. a transaction backend module connecting the Virtual PIN pad to a payment institution through a secure channel, the transaction backend module enabling the payment transaction by securely transferring the entered PIN from the Virtual PIN pad to the payment institution, and a payment authorization code or a payment refusal intimation from the payment institution to the Virtual PIN pad.

2. The system of claim 1 wherein the Virtual PIN pad comprises:
a. means for displaying a pay order received from a merchant to the customer for making a payment;
b. means for allowing the user to select an appropriate account identifier card using which the customer wishes to make the payment for the pay order; and
c. means for allowing the user to enter the PIN associated with the selected account identifier card.

3. The system of claim 2 wherein the Virtual PIN pad further comprises a means for allowing the customer to view the transaction history of the customer, the transaction history of a customer comprising details of all transactions made by the customer using the Virtual PIN pad integrated with the mobile device.

4. The system of claim 1 wherein the Virtual PIN pad comprises application logic to encrypt the entered PIN and make a secure connection to the transaction backend module.

5. The system of claim 1 wherein the Virtual PIN pad comprises application logic to decrypt the information received from the payment institution during the process of executing the transaction.

6. The system of claim 1 wherein the Virtual PIN pad comprises application logic for receiving a pay order comprising a payment amount sent by the merchant and displaying it to the customer.

7. A method for provisioning a Virtual PIN pad system on a mobile device for making payments to one or more merchants through the mobile device, the mobile device having access to a transaction backend through an electronic network, the method comprising the steps of:
a. generating a PIN pad ID for the Virtual PIN pad that needs to be provisioned on the mobile device;
b. registering the generated PIN pad ID;
c. generating and attaching a master key for the Virtual PIN pad after registration, the master key being generated and attached to the Virtual PIN pad by the transaction backend;
d. downloading the Virtual PIN pad onto the mobile device, the download being done through the electronic network onto the mobile device;
e. generating a decrypting key corresponding to the PIN pad ID of the virtual PIN pad that is downloaded on the mobile device, the decrypting key being generated by the transaction backend;
f. sending the decrypting key to the downloaded Virtual PIN pad, the decrypting key being sent by the transaction backend to the downloaded Virtual PIN pad through an electronic network; and
g. decrypting the master key with the decrypting key sent to the downloaded Virtual PIN pad for activating the downloaded Virtual PIN pad.

8. The method of claim 7 wherein the method for provisioning the Virtual PIN pad on the mobile device for making mobile payments through the mobile device further comprises the steps of:
a. selecting one or more merchants with whom the transactions need to be done using the activated Virtual PIN pad; and
b. registering the PIN pad ID corresponding to the activated Virtual PIN pad with the group of merchants, the registration being done through the transaction backend.

9. A method of making payments using at least one mobile device, the mobile device being used by a customer and comprising an embedded Virtual PIN pad, the payment being made by the customer to a merchant's online portal, the method comprising the steps of:
a. selecting an item for purchase from the merchant's online portal, the selection being made by the customer;
b. capturing a customer ID for identifying the customer;
c. sending a pay order from the merchant's online portal to a transaction backend;
d. sending the received pay order from the transaction backend to the mobile device being used by the customer;
e. entering a Personal Identification number (PIN) into the Virtual PIN pad integrated with the mobile device being used by the customer, the PIN being entered by the customer to authorize the payment;
f. encrypting the PIN entered by the customer;
g. sending the encrypted PIN from the Virtual PIN pad integrated with the mobile device being used by the customer to the transaction backend over a first secure channel;
h. sending the encrypted PIN from the transaction backend to a payment institution over a second secure channel to authorize payment to the merchant's online portal;
i. verifying the encrypted PIN for authorizing the payment, the verification being done by the payment institution;
if the transaction is authorized by the payment institution,
j. sending a payment authorization code to the merchant's online portal, the payment authorization code being sent by the payment institution through the transaction backend;
else
k. sending a payment refusal intimation to the merchant's online portal, the payment refusal intimation being sent by the payment institution through the transaction backend.

10. The method of claim 9 wherein the pay order is sent by the merchant's online portal to the transaction backend through one or more electronic networks that connect the merchant's online portal to the mobile device being used by the customer.

11. The method of claim 9 wherein the pay order comprises a payment amount and the customer ID.

12. The method of claim 9 wherein the encryption of the entered PIN is done by the Virtual PIN pad integrated with the mobile device being used by the customer.

13. A method of making payments using at least one mobile device, the mobile device being used by a customer and comprising an embedded Virtual PIN pad, the payment being made by the customer to a merchant, the customer's mobile device having access to a network that connects it to a transaction backend, the method comprising the steps of:
a. entering a pay order comprising a payment amount into a transfer device, the transfer device being used by the merchant and the pay order being entered by the merchant into the transfer device;
b. sending the pay order from the transfer device to a transaction backend;
c. sending the pay order from the transaction backend to the Virtual PIN pad integrated with the mobile device being used by the customer;
d. entering a Personal Identification number (PIN) into the Virtual PIN pad integrated with the mobile device being used by the customer, the PIN being entered by the customer to authorize payment to the merchant;
e. encrypting the PIN entered by the customer;
f. sending the encrypted PIN from the Virtual PIN pad to the transaction backend over a first secure channel;
g. sending the encrypted PIN from the transaction backend to a payment institution over a second secure channel to authorize the payment to the merchant;
h. verifying the encrypted PIN for authorizing the payment, the verification being done by the payment institution;
if the transaction is authorized by the payment institution,
i. sending a payment authorization code to the merchant and to the Virtual PIN pad integrated with the mobile device being used by the customer, the payment authorization code being sent by the payment institution through the transaction backend;
else
j. sending a payment refusal intimation to the merchant and to the Virtual PIN pad integrated with the mobile device being used by the customer, the payment refusal intimation being sent by the payment institution through the transaction backend.

14. The method of claim 13 wherein the transfer device is a computing device or a mobile device.

15. The method of claim 13 wherein the pay order is sent from the transfer device being used by the merchant to the transaction backend using an electronic network.

16. The method of claim 13 wherein the payment authorization code is sent by the payment institution over an electronic network.

17. The method of claim 13 wherein the encryption of the entered PIN is done by the Virtual PIN pad integrated with the mobile device being used by the customer.

18. A method of making payments using a first mobile device being used by a merchant and a second mobile device being used by a customer, the second mobile device comprising a Virtual PIN pad integrated with the mobile device, the payment being made by the customer to the merchant, the second mobile device not having access to a network that can connect it to a transaction backend, the method comprising the steps of:
a. entering a pay order comprising a payment amount into the first mobile device;
b. sending the entered pay order from the first mobile device to the Virtual PIN pad integrated with the second mobile device;
c. entering a Personal Identification number (PIN) into the Virtual PIN pad integrated with the second mobile device, the PIN being entered by the customer to authorize the payment to the merchant;
d. encrypting the PIN entered by the customer;
e. sending the encrypted PIN from the second mobile device to the first mobile device;
f. sending the encrypted PIN from the first mobile device to the transaction backend over a first secure channel;
g. sending the encrypted PIN from the transaction backend to a payment institution over a second secure channel to authorize the payment to the merchant;
h. verifying the encrypted PIN for authorizing the payment, the verification being done by the payment institution;
if the transaction is authorized by the payment institution,
i. sending a payment authorization code to the first mobile device and to the Virtual PIN pad integrated with the second mobile device, the payment authorization code being sent by the payment institution through the transaction backend;
else
j. sending a payment refusal intimation to the first mobile device and to the Virtual PIN pad integrated with the second mobile device, the payment refusal intimation being sent by the payment institution through the transaction backend.

19. The method of claim 18 wherein information is exchanged between the first mobile device and the second mobile device using an Infrared or Bluetooth connection.

20. The method of claim 18 wherein the encryption of the entered PIN is done by the Virtual PIN pad integrated with the second mobile device.

21. The method of claim 18 wherein the pay order is entered manually by the merchant, or using an automated product information generation system.

22. A method of making payments using a mobile device, the mobile device being used by a customer to place a voice-based order for a product or service with a merchant, the mobile device comprising a Virtual PIN pad integrated with the mobile device, the customer having a unique customer ID and the payment being made by the customer to the merchant, the mobile device having access to a network that connects it to a transaction backend, the method comprising the steps of:
a. contacting the merchant and placing a voice-based order, the contact being established by the customer using the mobile device;
b. providing the unique customer ID of the customer to the merchant, the unique customer ID being provided by the customer;
c. generating a pay order, the pay order being generated by the merchant for the customer;
d. sending the pay order to the Virtual PIN pad integrated with the mobile device, the pay order being sent by the merchant to the Virtual PIN pad through the transaction backend by using the unique customer ID;
e. entering a Personal Identification number (PIN) into the Virtual PIN pad integrated with the mobile device, the PIN being entered by the customer to authorize the payment to the merchant;
f. encrypting the PIN entered by the customer;
g. sending the encrypted PIN from the mobile device to the transaction backend over a first secure channel;
h. sending the encrypted PIN from the transaction backend to a payment institution over a second secure channel to authorize the payment to the merchant;
i. verifying the encrypted PIN for authorizing the payment, the verification being done by the payment institution;
if the transaction is authorized by the payment institution,
j. sending a payment authorization code to the first mobile device and to the Virtual PIN pad integrated with the second mobile device, the payment authorization code being sent by the payment institution through the transaction backend;
else
k. sending a payment refusal intimation to the first mobile device and to the Virtual PIN pad integrated with the second mobile device, the payment refusal intimation being sent by the payment institution through the transaction backend.

23. The method of claim 22 wherein the transfer device is a computing device or a mobile device.

24. The method of claim 22 wherein the payment authorization code is sent by the payment institution through the transaction backend over an electronic network.

25. The method of claim 22 wherein the encryption of the entered PIN is done by the Virtual PIN pad integrated with the mobile device being used by the customer.

26. A computer program product comprising a computer usable medium having a computer readable program code embodied therein, for making payments using at least one mobile device being used by a customer, the mobile device comprising an embedded Virtual PIN pad, the payment being made by the customer to a merchant, the computer program product comprising:
a. program instruction means for prompting the customer to enter a Personal Identification Number (PIN) into the Virtual PIN pad integrated with the mobile device, the PIN being required for authorizing the payment;
b. program instruction means for encrypting the entered PIN;
c. program instruction means for sending the encrypted PIN to a transaction backend over a first secure channel;
d. program instruction means for enabling the transaction backend to send the encrypted PIN to a payment institution over a second secure channel for payment authorization;
e. program instruction means for enabling the payment institution to verify the encrypted PIN for authorizing the payment;
f. program instruction means for enabling the payment institution to send a payment authorization code to the merchant and to the Virtual PIN pad integrated with the mobile device, if the payment is authorized; and
g. program instruction means for enabling the payment institution to send a payment refusal intimation to the merchant and to the Virtual PIN pad integrated with the mobile device, if the payment is not authorized.
